(19) United States
(12) Patent Application Publication
(10) Pub. No.: US 2017/0169163 A1
(43) Pub. Date: Jun. 15, 2017

(54) METHODS AND SYSTEMS FOR GENOME COMPARISON

(71) Applicant: Ramot at Tel-Aviv University Ltd., Tel-Aviv (IL)

(72) Inventors: Noam SHOMRON, Tel-Aviv (IL); Ofer ISAKOV, Tel-Aviv (IL); Gershon CELNIKER, Tel-Aviv (IL); Nir PILLAR, Tel-Aviv (IL)

(21) Appl. No.: 15/127,417

(22) PCT Filed: Mar. 16, 2015
(86) PCT No.: PCT/IL2015/050279

§ 371 Date: Sep. 20, 2016

Related U.S. Application Data
(60) Provisional application No. 61/955,841, filed on Mar. 20, 2014.

(51) Int. Cl. G06F 19/28; G06F 19/22

(52) U.S. Cl. CPC G06F 19/28; G06F 19/22

(57) ABSTRACT

There is provided a method for matching subject data to database patient data based on matching phenotypes and related genetic sequences, comprising: receiving a dataset including at least one phenotype disease description of a subject and a genetic sequence of the subject, the phenotype disease description describing clinically significant manifestations of disease in the subject; calculating a ranking score for each of a dataset of patients, the ranking score indicative of a similarity correlation between the dataset of each respective patient and the dataset of the subject, wherein the related genetic sequences of the dataset of patients are underlying genetic mutations attributable to the at least one phenotypic disease description; matching the dataset of the subject with at least one dataset of patients according to a requirement of the ranking score; and providing data indicative of the matched patients.

### RELATED APPLICATION

This application claims the benefit of priority under 35 USC §119(e) of U.S. Provisional Patent Application No. 61/955,841 filed Mar. 20, 2014, the contents of which are incorporated herein by reference in their entirety.

### BACKGROUND

The present invention, in some embodiments thereof, relates to methods and systems for processing genetic data and, more specifically, but not exclusively, to methods and systems for comparing genetic data between individuals.

Each person has a unique DNA sequence. However, different people may have certain sub-sequences in common, for example, genes that code for certain proteins. Methods have been developed to analyze the DNA of a subject to identify genetic variations that may be associated with different health states of subjects, such as risk factors for different diseases. For example, the DNA sequence of a subject may be analyzed to try and detect the presence of genetic mutations associated with increased risk of cancer, such as detecting the presence of the BRCA1 gene associated with early onset of breast cancer. The genetic sequence of a subject may be analyzed to identify associations with other diseases, for example, neurological disorders, hematological disorders, and cardiovascular disorders.

### SUMMARY

According to an aspect of some embodiments of the present invention there is provided a computer implemented method for matching subject data to database patient data based on matching phenotypes and related genetic sequences, comprising: receiving, by a matching unit, a dataset including one or more phenotype disease descriptions of a subject and a genetic sequence of the subject, the phenotype disease description describing clinically significant manifestations of disease in the subject; calculating, by the matching unit, a ranking score for each of a dataset of patients stored in a database including the phenotypic disease description and related genetic sequences of the patients, the ranking score indicative of a similarity correlation between the dataset of each respective patient and the dataset of the subject, wherein the related genetic sequences of the patients stored in the database are underlying genetic mutations attributable to the one or more phenotypic disease descriptions; matching, by the matching unit, the dataset of the subject with one or more datasets of patients according to a requirement of the ranking score; and providing data indicative of the matched patients for one or more of: presentation on a display, storage on a storage medium, and forwarding to a processor or code module.

Optionally, the method further comprises ranking the matched patients, by the matching unit, based on the ranking score, and providing the highest ranked matched patients according to a predefined requirement.

Optionally, the subject dataset and each patient dataset includes additional data selected from the group consisting of: geographic location, ethnic background, physiological measurements, medical treatments, family history, age, and gender, and wherein the ranking score includes a sub-score indicative of the similarity correlation between the additional data of the subject dataset and each patient dataset.

Optionally, datasets of patients with similar phenotypic disease descriptions and variations in genetic mutations associated with the phenotypic disease descriptions are matched to the dataset of the subject.

Optionally, matching comprises correlating based on variations of the related genetic sequences of patients in the database.

Optionally, providing comprises formatting the provided data for visually displaying, on a display, the datasets of the matched patients to visually indicate similar genetic sequences and/or similar phenotypic disease descriptions.

Optionally, providing comprises formatting the provided data for visually displaying, on a display, the datasets of the matched patients to visually indicate differences in genetic sequences and/or differences in phenotypic disease descriptions.

Optionally, providing further comprises color coding related genetic sequences of the dataset of the patients and the dataset of the subject, wherein similar colors indicate similar genetic sequences.

Optionally, the phenotypic disease description comprises metadata indicative of a disease diagnosis. Optionally, the disease diagnosis is based on International Classification of Diseases (ICD) diagnostic codes.

Optionally, the matching unit calculates the ranking score based on a sub-score indicative of clinical relevance of the phenotypic disease description.

Optionally, the matching unit calculates the ranking score based on one or more of: a sub-score indicative of rarity of the phenotypic disease description and a sub-score indicative of rarity of genetic mutations underlying the phenotypic disease description.

Optionally, the matching unit calculates the ranking score based on a sub-score indicative of a similarity correlation in phenotypic disease descriptions of the dataset of the subject and the dataset of the matched patients.

Optionally, providing comprises providing one or more of: data representing shared genetic variations, and data representing shared gene mutations of the dataset of the subject and the dataset of the matched patients.

Optionally, matching comprises matching, by the matching unit, based on a comparison of similarity of phenotypic disease descriptions to generate a first matching list according to a first requirement, and reducing the first matching list to a second matching list based on a comparison of similarity of underlying genetic mutations attributable to the phenotypic disease descriptions according to a second requirement.

Optionally, providing comprises providing metadata indicative of a description of genetic traits common to both the subject and matched patients.

Optionally, the method further comprises diagnosing, by the matching unit, one or more disease in the subject according to an analysis of the datasets of the matched patients.

Optionally, diagnosing comprises identifying, by the matching unit, a genetic association for the phenotypic disease description defined in metadata related to the dataset of the subject based on the genetic information of datasets of the matched patients.

Optionally, the method further comprises filtering the dataset of the matched patients according to data stored on a database of one or more of genetic mutations and polymorphisms, to identify one or more of known mutations and polymorphisms defined by the database.

Optionally, the method further comprises filtering the datasets of the matched patients according to data stored on a database of one or more of genetic mutations and polymorphisms to identify one or more of unknown mutations and unknown polymorphisms that are not defined by the database.

Optionally, the matching unit calculates the ranking score based on metadata defining one or more user defined features.

Optionally, matching unit calculates the ranking score based on metadata defining annotated variants of the dataset of matched patients according to genetic association of the variants to metadata of phenotypic disease description. Optionally, the annotation of the variants is based on a correlation with clinical relevance.

Optionally, the method further comprises adjusting the calculated ranking score, by the matching unit, based on metadata including feedback from one or more users.

According to an aspect of some embodiments of the present invention there is provided a system for matching a dataset including genotypes of a subject based on matching datasets including phenotypes and related genetic sequences, comprising: a matching unit, comprising: an interface configured to receive a dataset including one or more phenotype disease descriptions of a subject and a genetic sequence of the subject, the phenotype disease description describing clinically significant manifestations of disease in the subject; a non-transitory memory having stored thereon code; a database storing unit, the database storing datasets of patients including one or more phenotypic disease descriptions and related genetic sequences, wherein the related genetic sequences of patients stored in the database are underlying genetic mutations attributable to the one or more phenotypic disease descriptions; and a hardware processor coupled to the interface, the database storing unit, and the non-transitory memory for implementing the stored code, the code comprising: code to calculate a ranking score for each of the datasets of patients stored in the database, the ranking score indicative of a similarity correlation between the dataset of each respective patient and the dataset of the subject; wherein the interface is further configured to provide the datasets of patient datasets matched to the subject dataset according to a requirement of the ranking score, for one or more of: presentation on a display, storage on a storage medium, and forwarding to a processor or code module.

Optionally, the system further comprises a graphical user interface (GUI) in communication with the interface, the GUI configured to present the matched patients with the ranking score for display on a display of a client terminal.

Optionally, the client terminal is a Smartphone configured to remotely access the interface via a wireless network connection.

Optionally, a client terminal includes a wireless communication interface to wirelessly communicate with the interface implemented on a web server which is accessible over a network connection. Optionally, the GUI is in communication with a custom user gene list generator stored on the client terminal configured for allowing a user to generate a custom list of subjects for matching.

Optionally, the database is stored in a computing cloud.

Optionally, a client terminal provides two or more subject datasets to the matching unit, and the code of the matching unit calculates the ranking score for one or the subject datasets relative to the other subject datasets.

According to an aspect of some embodiments of the present invention there is provided a computer program product for matching subject data to database patient data based on matching phenotypes and related genetic sequences for use by a matching unit, comprising: program instructions to receive a dataset including one or more phenotype disease descriptions of a subject and a genetic sequence of the subject, the phenotype disease description describing clinically significant manifestations of disease in the subject; program instructions to calculate a ranking score for each of a dataset of patients stores in a database including the phenotypic disease description and related genetic sequences of the patients, the ranking score indicative of a similarity correlation between the dataset of each respective patient and the dataset of the subject, wherein the related genetic sequences of the patients stored in the database are underlying genetic mutations attributable to the one or more phenotypic disease descriptions; program instructions to match the dataset of the subject with one or more dataset of patients according to a requirement of the ranking score; and program instructions to provide data indicative of the matched patients for one or more of: presentation on a display, storage on a storage medium, and forwarding to a processor or code module.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method that matches received subject data to stored patient data according to correlation between phenotypes and related underlying genetic sequences, in accordance with some embodiments of the present invention;

FIG. 2 is a block diagram of components of a system, including a matching module, that matches received subject data with stored patient data, in accordance with some embodiments of the present invention;

FIG. 3 is a flowchart of a method based on the method of FIG. 1, including optional features, such as annotation of the dataset, incorporation of received datasets into the patient database, automatically generating a diagnosis, and/or filtering of data, in accordance with some embodiments of the present invention;

FIG. 4 is a screen shot of the GUI of the matching system on the display of the client terminal, in accordance with some embodiments of the present invention;

FIG. 5 is another screen shot of the GUI of the matching system, in accordance with some embodiments of the present invention;

FIG. 6 is yet another screen shot of the GUI of the matching system, in accordance with some embodiments of the present invention;

FIG. 7 is yet another screen shot of the GUI of the matching system, in accordance with some embodiments of the present invention;

FIG. 8 is yet another screen shot of the GUI of the matching system, in accordance with some embodiments of the present invention;

FIG. 9 is yet another screen shot of the GUI of the matching system, in accordance with some embodiments of the present invention;

FIG. 10 is yet another screen shot of the GUI of the matching system, in accordance with some embodiments of the present invention;

FIG. 11 is yet another screen shot of the GUI of the matching system, in accordance with some embodiments of the present invention;

FIG. 12 is a graphical representation of a method for listing candidates based on similar genomic data, in accordance with some embodiments of the present invention;

FIG. 13 is a schematic chart of a method of comparing genetic information based on similarity of colors, in accordance with some embodiments of the present invention;

FIG. 14 is a flowchart of a method of visualizing comparisons of genetic data, in accordance with some embodiments of the present invention; and

FIG. 15 is a table of some examples of databases and/or software modules which may be combined with the method of FIG. 1, and/or accessed by the matching module and/or accessed by the client terminal of FIG. 2, in accordance with some embodiments of the present invention.

### DETAILED DESCRIPTION

The present invention, in some embodiments thereof, relates to methods and systems for processing genetic data and, more specifically, but not exclusively, to methods and systems for comparing genetic data between individuals.

As described herein, the phrase phenotypic disease description sometimes means clinically apparent signs and/or symptoms of disease. The phrase phenotypic disease description sometimes refers to a diagnosis of a disease. The disease diagnosis may be based on International Classification of Diseases (ICD) diagnostic codes. The phenotypic disease description may have underlying genetic mutations attributable to the phenotypic expression of the disease. The underlying genetic mutations may be known (i.e., within a public database) or yet unknown (i.e., not yet discovered, not yet within the public database).

As described herein, the phrase clinically significant sometimes means signs and/or symptoms and/or other disease manifestations which may be treated using existing medical methods (e.g., drugs, surgery, and physiotherapy), which affect the quality of life of a patient, and/or otherwise require the attention of a healthcare provider.

As described herein, the term subject or individual refers to the data of the person who the search is being conducted for (e.g., provided by the user). The term patients refers to the set of data (e.g., within a database) that is searched for a match with the subject data.

An aspect of some embodiments of the present invention relates to a matching unit that automatically matches a dataset of a subject including a phenotypic disease description and a genetic sequence with one or more datasets of patients stored in a dataset, including phenotypic disease descriptions and related genetic sequences. The related genetic sequences of patients in the database are underlying genetic mutations attributable to the phenotypic disease description. In this manner, the matching may be based on matching both the phenotypic disease description, and the genetic sequences underlying the phenotypic disease description. The matching unit focuses the matching process to obtain a focused set of matched datasets, which are closely correlated with the subject dataset. The matching module may obtain clinically relevant matches, by match dataset of a subject with datasets of patients based on clinical relevant disease conditions (e.g., defined by phenotypic metadata associated with each dataset), the matched datasets of which may include relevant patient data to direct diagnosis and/or treatment of the patient. For example, the subject may be diagnosed using the same diagnosis given to the matched patient, and/or treated using the same treatment which has been effective for the matched patient. The matching module may exclude genetic mutations that are not expressed, and/or not relevant to the phenotypic disease descriptions from the matched patient datasets.

Optionally, the matching unit calculates a ranking score for each (or subset) of the patient datasets. Optionally, the ranking score is calculated based on the similarity and/or correlation between each respective patient dataset and the subject dataset, for example, more similar datasets having higher ranking scores. The associated ranking score may be outputted with the matched patient datasets.

The matching unit may allow a physician (or other healthcare provider) having a subject with a given phenotypic disease description, to search for other patients with similar phenotypic disease descriptions. The genetic sequences of the subject may be compared to the stored patient datasets. The comparison may help in diagnosing and/or identifying clinically significant genetic mutations of the subject, based on known matched genetic mutations of the patients.

Optionally, the matching unit ranks the patient dataset for similarity with the subject dataset based on a predefined requirement, for example, based on a probability of matching the dataset subject above a threshold. Patient datasets meeting the requirements may be defined herein as being matched. The highest ranked patient datasets meeting the requirements may be displayed on a display of a client terminal in communication with the matching unit. The top few matches may be selected, which may reduce the list of matches to the most important and/or relevant ones.

Optionally, the matching unit performs the matching based on a reductionist approach, to reduce the number of initial matches and arrive at a smaller set of the closest matches. Multiple matches may be performed, where each additional match is performed based on the top matches of the previous matching process. Optionally, the patient datasets are first matched to the subject dataset based on the phenotypic disease description according to a first requirement, to generate a first list. The first set of matches may be ranked, with the top matches (or all matches meeting the requirement) selected for a second round of matching. The second round of matching may be based on matching the underlying genetic mutations attributable to the matched phenotypic disease description according to a second requirement. The match results may be ranked. The top matches may be selected again for another round of matching according to a third requirement, for example, matching based on other factors, for example, genetic variations, geographic location, ethnic background, physiological measurements, medical treatments, family history, age, gender, and/or other factors. The different matches may be performed sequentially, in parallel, simultaneously, and/or using other techniques to arrive at the same resulting set. In this manner, the closest matches to the subject may be provided, for example, a match of one patient, 3 patients, 5 patients, or other number of patients.

Optionally, the overall approach of the matching unit includes taking multiple comparisons of as many genomes and/or phenotypes (clinical descriptions) as possible. Optionally, a reductionist approach is then applied to pinpoint the findings to particular genes.

Optionally, a viewer module, such as a graphical user interface (GUI), of a client terminal is in communication (e.g., over a network connection) with a central server (or other suitable processor) running the matching unit. The GUI provides an interface for uploading human genomic variation data to the central server, for example, from deep sequencing or other technologies. Optionally, various comparisons are performed of a subject's set of variations, for example, in order to detect the rarest and/or most clinically relevant ones.

Optionally, the matching unit provides the matched dataset results for presentation on a display of the client terminal, for example a display on a mobile device, such as a Smartphone, a Tablet computer, and a Laptop computer or other suitable media devices and/or display devices. Optionally, the Smartphone (or other mobile and/or client device) runs a client module to interface with the central server, for example, through the internet. The central server may perform the matching method described herein. The client module may display the results of the match.

The subject dataset (e.g., including the genome, phenotype description and/or other data) may be compared to one or more other subject datasets provided by the user. The comparison may be performed to identify mutations common to both datasets, for example, a male genome and a female genome before conception. The comparison between subject datasets may be performed by the central management unit using datasets uploaded from the client terminal. The ranking score and/or degree of correlation between the datasets may be calculated.

Optionally, additional module layers are added to filter the matches, for example, onto the GUI module and/or by the matching unit, for example, databases of mutations that lead to diseases (e.g., based on ENSEMBL or other databases) and/or mutations and/or polymorphisms that affect drug metabolism (e.g., based on PharmGKB or other databases). Optionally, the patients are filtered based on the database to identify known mutations and/or polymorphisms within the database. Alternatively or additionally, the patients are filtered based on the database to identify unknown mutations and/or polymorphism. Other filtering types may be possible, for example, based on selected known values of the database, based on clinically significant mutations, and/or based on other factors. Filtering according to the databases may remove irrelevant matches, for example, datasets that coincidentally match in unexpressed genetic material (which is clinically irrelevant since such sequences are not expressed). Filtering according to the databases may focus on matching known mutations and/or variations.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

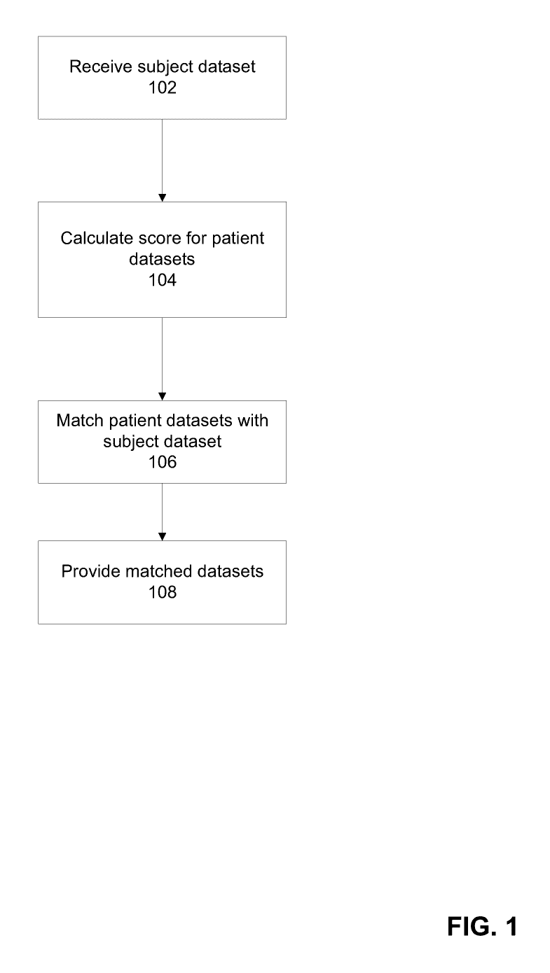

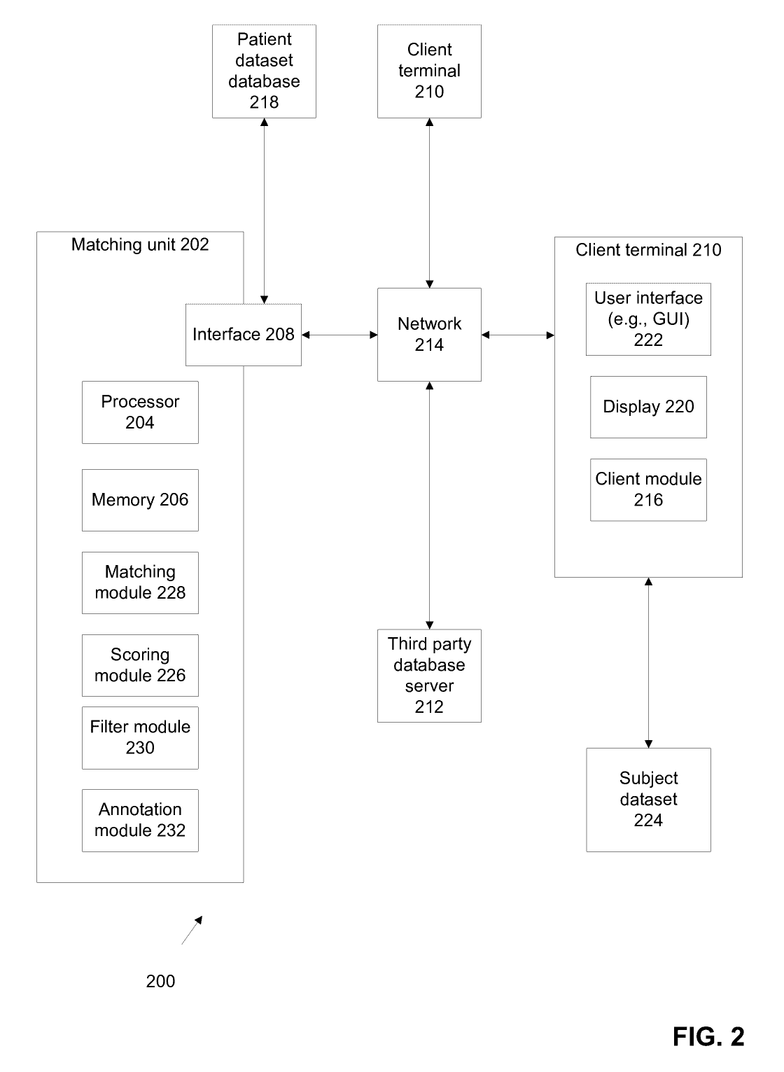

Reference is now made to FIG. 1, which is a flowchart of a method that matches received subject data to stored patient data according to correlation between phenotypes and related underlying genetic sequences, in accordance with some embodiments of the present invention. Reference is also made to FIG. 2, which is a block diagram of components of a system, including a matching module, that matches received subject data with stored patient data, allowing a user to identify datasets of other patients according to correlations between phenotypic disease descriptions and related genetic sequences, in accordance with some embodiments of the present invention. The method of FIG. 1 may be executed by the system of FIG. 2.

The matching unit may improve performance of a computing device executing the matching unit, by reducing memory requirements and/or processor utilization. For example, instead of the user accessing multiple different modules, and then trying to combine results from the different modules with yet another module, for example, the user accessing one module to find datasets of patients with correlated genetic sequences, another module to find datasets of patients with correlated diagnosed medical conditions, and yet another module to sort and analyze the results from the two modules according to similar patients.

The matching module provides new patient dataset matching features that do not have direct corresponding manual actions. For example, due to the large size of the human genome, the number of genetic variations available, and the different phenotypic manifestations that appear in different people, the correlation described herein between a received dataset of a subject with datasets of patients stored in a database involves a very large number of possible combinations, which cannot be evaluated manually by a human (e.g., using a pen and paper).

The matching module may improve the processing efficiency and/or technical effects of existing genetic systems. The same genetic variation may manifest itself as different phenotypic expressions in different people. For example, one person may develop a full manifestation of the disease, one person may not develop the disease at all, and yet another person may partially develop the disease (e.g., a minor manifestation). The same or similar phenotypic expressions in different people may be linked with different genetic variations and/or different genetic sequences. For example, two people may develop a similar disease due to different genetic mutations. As such the matching module may be added to existing genetic systems, which may only perform identification of known genetic mutation sequences (e.g., BRCA1), to improve the existing genetic systems in being able to match datasets of clinically relevant patients.

The matching unit may perform genome parsing, analysis, ranking and/or comparison is described.

System 200 includes a matching unit 202, which includes a processor 204 coupled to a memory 206 storing code implementable by processor 204 for matching subject data to patient data according to matching phenotype data and related genetic sequences, as described herein. Processor 204 is coupled to interface 208, such as to process data received via interface 208 and/or provide data to interface 208 for transmission.

Matching unit 202 may be implemented as a server, such as a central server, optionally a web-bases server. Alternatively or additionally, matching unit 202 may be implemented on a computer, such as a desktop computer, or a mobile device (e.g., a Smartphone, a Tablet computer, and a laptop computer).

Matching unit 202 may include an interface 208 for communicating with external computers and/or storage devices. Interface 208 may include network connection capabilities (e.g., local area network, and/or internet), wireless connectivity, wired connectivity, and/or an abstract interface (e.g., application programming interface) for local and/or remote connectivity. Matching unit 202 may communicate with one or more client terminals 210 and/or other servers 212 (e.g., hosting third party databases), such as over a network 214. Examples of client terminals 210 include desktop computers and/or mobile devices, for example, Smartphones, Tablet computers, and/or laptop computers.

Each client terminal 210 may include a processor for local execution of code, such as a client module 216 locally installed on client terminal 210 containing instructions for communicating with matching unit 202, and/or for local processing of match related data as described herein. Client terminal 210 may include or be in communication with a display 220 for displaying a user interface, such as according to code stored within a graphical user interface 222 implementable by the processor of the client terminal for displaying match related data and/or allowing a user to enter commands to control the matching process, as described herein.

Optionally, GUI 222 presents the data of the matched patients (received from matching unit 202) optionally with the related ranking score, on display 220.

Matching unit 202 may stored thereon and/or be in communication with a patient database 218 stored on a storing unit (e.g., on a remote database server, on a local computer, on matching unit 202 in communication with processor 204, and/or on memory 206), dataset 218 stores phenotype and related genetic sequences for matching to subject data, as described herein. Database 218 may store patient data, for example, as records, files, as abstract objects, in a matrix, and/or in an array. Patient data may be stored as text, optionally secured, for example, encrypted. Patient data may be arranged according to a predefined standard for storing genetic data.

Matching unit 202 utilizes shared information regarding genotype and/or phenotype associations, for example, in order to improve diagnosis and/or better pinpoint candidate, clinically relevant genes and/or variations, as described herein.

Matching unit 202 may utilize an optional cloud-based resource, such as database 218, containing previous information gathered by matching unit 202, which holds genetic events common to individuals sharing various combinations of phenotypes. Matching unit 202, analyses queries of specific phenotypes together with a subject's set of genetic variants, and provides an output describing shared variations and/or genes that are present in other, previously sequenced individuals sharing some or all of the subject's phenotypes, which are stored in database 218. Cloud storage of database 218 may allow dynamic allocation of storage space, as the size of database 218 grows with increased number of samples (e.g., each received subject data may be added to the database). Cloud storage may provide access to the same stored patient data from different geographical locations, for example, when multiple matching units 202 exist at different geographical locations.

System 200 may address a technical bottleneck of genetic data analysis and interpretation. A physician may be able to view their patient's genome sequence, integration of genomic and/or clinical data from different geographical locations around the world, to parse and/or focus the clinical manifestation to a particular gene, genes or pathway.

System 200 may provide unprecedented accessibility, for example, for private variants and/or shared public features. For example, system 200 allows a user to browse and/or look at their own genome, such as on a mobile device (e.g., Smartphone).

Matching unit 202 may perform one or more of: genome parsing, analysis, ranking and/or comparison for the human genome. Optionally, matching unit 202 allows for the multiple integration of data from various experiments and/or datasets, for example, by annotating genetic sequences based on experimental results. Matching unit 202 provides for viewing the results on several levels, for example, the entire matched genome, and visual color coded matched mutations. At 102, a dataset 224 including a phenotype disease description of a subject and a genetic sequence of the subject in received at matching unit 202, optionally via interface 208. The phenotype disease description includes metadata describing clinically significant manifestations of disease in the subject. The phenotypic disease description may be, for example, text, codes defined by a standard (e.g., medical condition codes), and/or key words.

It is noted that dataset 224 may include a complete genetic sequence of the genome, or one or more partial genetic sequences, for example, of a chromosome or part of a chromosome. Genetic information included within dataset 224 may include nucleic acids, such as DNA or RNA, coding and/or non-coding RNA expression, and any other genetic or epigenetic modifications such as acetylations, methylations, or others.

Optionally, subject datasets 224 and/or patient datasets stored in database 218 include additional related information, for example, annotated genes, features, physiological measurements, patient medical history, and/or phenotype descriptions. Calculated scores (e.g., as in block 104) and/or matching requirements (e.g., as in block 106) may be defined according to the additional related information, for example, to match patients of similar ages, similar co-existing chronic diseases, and similar blood pressures.

The dataset may be transmitted by client terminal 210 to matching unit 202 over network 214, for example, as network packets and/or network frames. The dataset may be, for example, a text file containing metadata of the genetic sequence and/or phenotype description, and/or code defining the genetic sequence and/or phenotype description. The dataset may be organized according to a predefined standard, for example, the standard used for organizing patient data in database 218.

Dataset 224 may be obtained from sequencing of a human genome(s) of the subject, or part thereof, for example, outputted by an automated sequencing machine. It is noted that the sequencing may be obtained from different cells of the body, for example, cells from a tumor (which may be a rare cancer) of the subject may be sequences and matched using the matching unit, for example, to try and diagnose the cancer, and/or identify other patients with similar cancers that have been effectively treated.

For incorporating genetic data into clinical diagnosis and/or prognosis, the received dataset may include a list of variants (e.g., in Variant Call Format (VCF)) from one or more subjects that may or may not be related and/or may or may not share similar phenotypes. Any other relevant file format may also be used as input.

Optionally, variant genetic data for the subject, and/or additional subjects that may or may not be related to the subject and/or may or may not share similar phenotypes are transmitted from client terminal 210 to matching unit 202. The subject data may be matched against the additional subjects provided from the client terminal, optionally in view of the patient data in database 218. The subjects data may be matched in view of the variant genetic data. In this manner, the user may select to calculate ranking scores between two user provided datasets. The user may select to broaden the ranking score calculation to include the genetic variations.

Optionally, client terminal 210 includes code implementable by the processor of the client terminal (e.g., a custom user gene list generator) for allowing a user to generate a custom list of subjects for matching. The custom user gene list may be used, for example, when a user has numerous genes and/or subjects to compare. The custom user gene list code allows generation of a custom list (e.g., in a single click of a button) and run the matching process executed by matching unit 202 on multiple user selected genomes and/or subjects simultaneously. The custom user gene list may be implemented by GUI 222.

Optionally, matching unit 202 is accessed by client terminal 210 of a physician (or other provider) after the subject has undergone sequencing and/or genetic variants have been gathered.

Optionally, a dataset of genetic variants, which may be associated with the genetic sequence of the subject, is transmitted to matching unit 202, optionally from client terminal 210. The genetic variants may be analyzed and matched by the matching unit to the subject data.

Optionally, at 104, matching unit 202 includes code (e.g., a scoring module 226) implementable by processor 204, that calculates a ranking score based on the received subject dataset 224. The ranking score is calculated for each (or a subset) of the datasets of patients stored in database 218. The ranking score is indicative of a similarity correlation between the dataset of the respective patients and the dataset of the subject, for example, a high similarity correlation value is indicative of a close match based on similar datasets, and a low similarity correlation value is indicative of significantly different datasets.

Database 218 includes the phenotypic disease description and related genetic sequences of the patients. The related genetic sequences of the patients stored in the database are underlying genetic mutations attributable to the at least one phenotypic disease description.

The received subject dataset is compared by phenotype and/or genetically compared against previously analyzed individuals (local and/or global) stored within database 218.

The ranking score may be represented as, for example, a single value, a function, or multiple values, such as a matrix, an array, or a vector. The ranking score may be calculated based on multiple sub-scores, and/or based on one or more functions. The ranking score may be calculated, for example, by a statistical classifier, a correlation module, a similarity function, or other mathematical methods.

Scoring module 226 may be implemented as an in-house script to calculate the ranking score. The ranking score may be computed according to the various features of the variants and/or genes, for example, computed for relevant variants, while optionally ignoring other non-relevant genetic sequences. The ranking score may facilitate the prioritization of the variants and/or possibly mark the most probable candidates to be associated to the subject(s) phenotypic disease description, as described herein.

Optionally, the ranking score may include a sub-score component based on clinical relevance of the phenotypic disease description. For example, phenotypic disease descriptions which greatly affect the quality of life of patients and/or which may be successfully treated and/or successfully managed may score higher (or lower) than phenotypic disease descriptions which may not affect the quality of life of patients and/or for which there is no good treatment and/or management options. The dataset of the subject may have higher similarity correlations with datasets of patients that have similar phenotypic disease descriptions of similar clinical relevance. The dataset of the subject may have higher similarity correlations with datasets of patients that have similar phenotypic disease descriptions that are of clinical relevance (phenotypic descriptions that are not clinically relevant may not be considered in the score). The dataset of the subject may have higher similarity correlation with datasets of patients that have medical conditions which are treatable using existing medical therapies (e.g., surgery, drugs, and/or physiotherapy). The ranking score based on clinical relevance may exclude or reduce the importance of genetic mutations that do not manifest in clinically relevant phenotypic expressions, and/or clinically significant phenotypic expressions that cannot be matched to underlying genetic mutations.

Alternatively or additionally, the ranking score may include a sub-score component based on rarity of the phenotypic disease description and/or rarity of genetic mutations underlying the phenotypic disease description. Rare phenotypes and/or genetic mutations may receive higher scores than common phenotypes and/or genetic mutations. The score may be based on the consideration that the physician may already be aware of common mutations and/or common phenotypic disease descriptions, and has already considered the common causes. Ranking score giving higher weight to rarity may present new ideas and/or a new diagnostic possibility to the physician.

Alternatively or additionally, the ranking score may include a sub-score component based on similarity in phenotypic disease descriptions of the subject and matched patients. For example, some disease manifestations may be graded on a predefined clinical scale. Similar grades on the clinical scale may receive higher ranking scores. In this manner, patients experiencing similar manifestations of severity of the disease may be matched together when their genetic sequences are less correlated than patients with similar genetic sequences but different manifestations of disease severity.

Alternatively or additionally, the ranking score may include a sub-score component based on one or more user defined features. The user may customize the matching processes by defining the ranking score.

Optionally, sub-scores are calculated per genetic unit, for example, per gene, per nucleotide, per predefined sequence, per chromosome, for all genetic data, and/or per annotation. Optionally, some genetic units are excluded from the scoring process, for example, regions of genetic code that do not code for proteins, and/or regions that are defined as not clinically significant (e.g., annotated segments).

Optionally, score are calculated to take into account variations in genetic sequences. For example, the subject dataset may be matched to a dataset of a patient having a variation of a genetic mutation corresponding to the genetic mutation of the subject dataset, when both subject and patient have matching phenotypic descriptions.

The components of the ranking score (e.g., weights assigned to each sub-score) may be predefined, automatically selected by code, and/or manually selected by the user (e.g., using a graphical user interface). The manual selection may be performed, for example, by the physician in view of the medical history of the patient, and previous failed treatments, for example, to try and find a matching patient that has been successfully treated for a similar phenotype related to a similar genetic sequence. The subject may be placed on the same or similar treatment regimen which has worked for the matched patient, with the expectation that the similar treatment may also help the subject.

Optionally, at 106, code (e.g., matching module 228 stored on matching unit 202) implementable by processor 204 matches the received dataset of the subject with one or more datasets of patients from database 218 according a requirement of the related calculated ranking score.

The ranking score is used by the matching module code to prioritize the datasets of the patients stored in database 218, for example, higher values of the ranking score indicate higher relevance and/or better matching of the matched patient to the subject. The ranking score may be comprised of different values, which may be integrated into a single value, such as by a weighted average. Alternatively, different ranking scores are calculated, with different sets of results available for viewing.

The requirement may be, for example, a set of rules, a threshold value, a range of values, and/or a function. For example, the requirement may define a threshold above which matches are deemed to be relevant. For example, the requirement may define a set of rules that define the matches as the three patient dataset with the highest ranking scores.

The requirement may be selected in view of the sub-scores of the ranking components. Sub-scores of the requirement may be defined based on the sub-scores of the ranking score, for example, sub-requirements for corresponding sub-scores.

Optionally, patients with similar phenotypic disease descriptions and variations in genetic mutations associated with the phenotypic disease descriptions are matched according to the requirement in relation to the calculated ranking scores. For example, a subject with a certain disease symptom with a certain genetic variation may be matched to a patient with a similar disease symptom, but having a different genetic variation based on the requirement applied to the ranking score. Optionally, the requirement is selected based on variations of the related genetic sequences of patients in the database, to include matches of the variations.

Optionally, the matching is performed by generating a first list of matches based on similar phenotypic disease descriptions defined by a first requirement. The list may be sorted based on the ranking score. The first list may be reduced to a second list based on comparison of similarity of underlying genetic mutations attributable to the phenotypic disease descriptions defined by a second requirement. The second requirement may include, for example, user selected features, ranking score values, matches with known genetic mutations and/or variations within an external database, and/or other methods.

At 108, data indicative of the matched patients is transmitted from matching unit 202 to client terminal 210, optionally via interface 208 and over network 214. The data may include the related ranking score. The received data may be formatted for display and/or displayed on display 220 of client terminal 210 by code (e.g., GUI 220) implementable by the processor of client terminal 210.

The data may include the dataset or part thereof, of each matched patient, including the genetic sequences and/or phenotypic expressions.

Optionally, additional data related to the matched patients is provided to client terminal 210, for example, details of medical treatments of each patient and optional effects of the treatments. In this manner, the physician may select to administer the same or similar treatment regimen of the matched patient to the subject.

Optionally, the data includes the description of the common genetic traits found in individuals demonstrating similar phenotypes.

Optionally, the data of the matched patients is visually displayed by GUI 222 on display 220. The GUI formats the data to indicate similar genetic sequences and/or similar phenotypic disease descriptions, for example, based on similar colors, markings, alignment of text, or other methods. Alternatively or additionally, the matched patients are formatted by GUI 222 for visual display on display 220 to indicate differences in genetic sequences and/or differences in phenotypic disease descriptions. For example, when a patient is closely matched to a subject, the differences between the patient and the subject may be more important to the physician than the many similarities.

Optionally, GUI 222 formats the received data to visually indicate and/or display differences in genetic variations between the subject and matched patients. Alternatively, the genetic variations are displayed as being the same, for example, genetic variations underlying similar phenotypic disease descriptions.

Alternatively or additionally, the data may be presented on a web server and/or may also be presented on a Smartphone application with a unique GUI that provides the end user with accessibility to vast genomic data and/or ability to compare private phenotypic and/or genotypic data to other shared genomes. An intuitively designed user interface (UI) may consist of easy to use menus and forms, for example, if a user wishes to compare one genome to other uploaded genomes the user may do so by clicking to select the genomes from the list and then clicking a compare button.

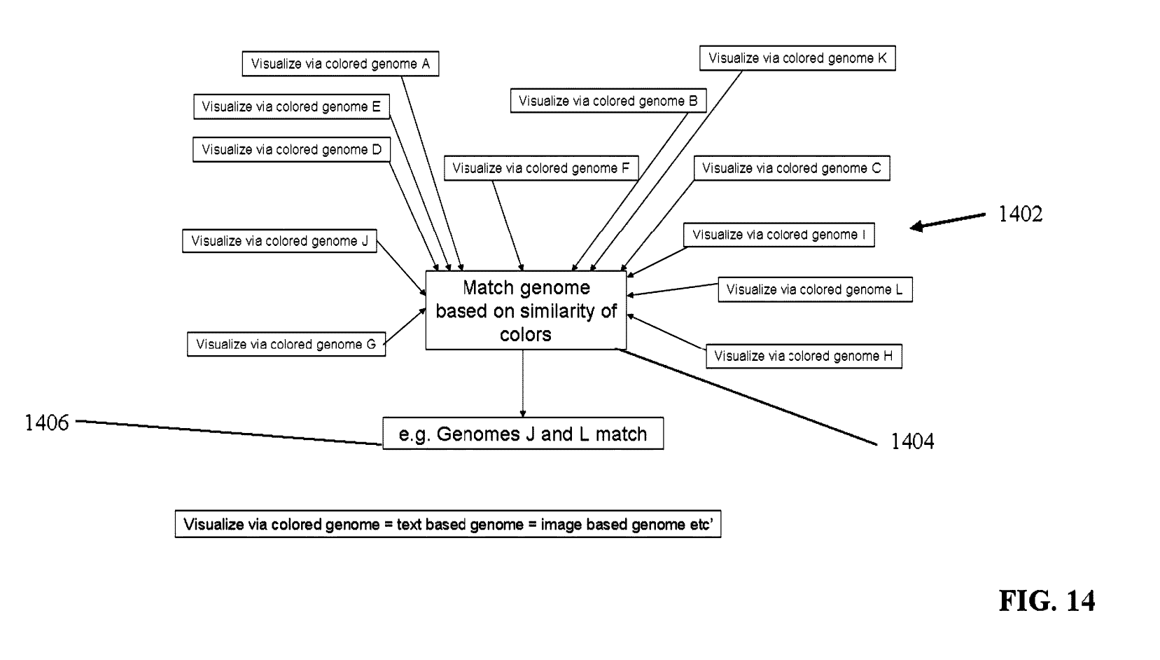

Reference is now made to FIG. 14, which is a flowchart of a method of visualizing comparisons of genetic data, in accordance with some embodiments of the present invention. The method may be executed by the GUI code implementable by the processor of the client terminal and/or by code of the matching unit, as described herein with reference to FIG. 2.

The method of FIG. 14 helps visualize matches between datasets of different subjects and/or patients, which may be provided by the user and/or obtained from database 218.

At 1402, datasets of different subjects and/or patients are displayed on display 220 in a color coded pattern. The genetic sequences of the datasets may be stored as text, which is mapped to different colors for display, for example, coloring may be performed for amino acids, nucleotides, introns, exons, and genes. The genetic sequences of the datasets may be stored as color codes, for example, an array within a red/green/blue (RGB) color space.

At 1404, the datasets are matched by the matching module, by the client terminal, and/or visually by the user. The datasets may be matched based on the color coding, for example, similarity between individual colors, and/or similarity between sequences of color patterns.

At 1406, the matched datasets are displayed on display 220 by GUI 222.

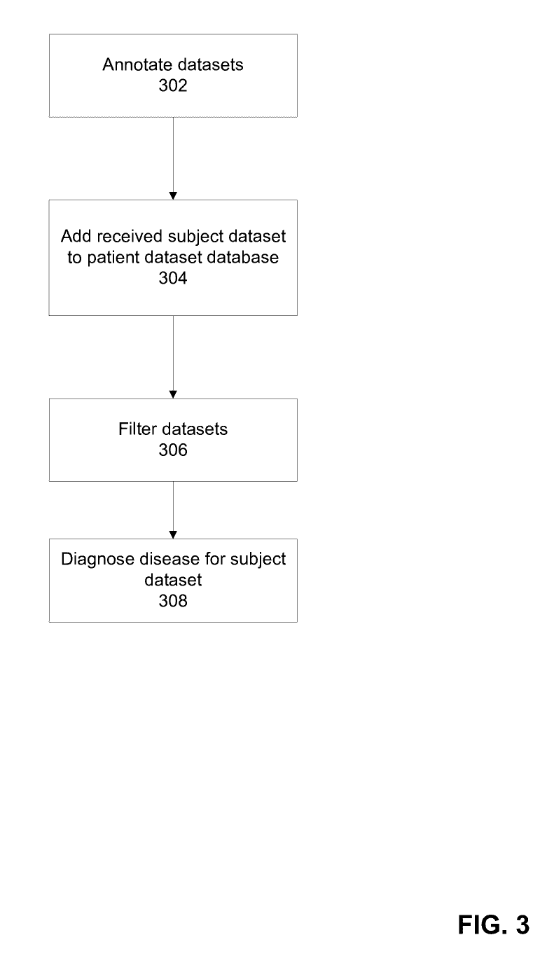

Reference is now made to FIG. 3, which is a flowchart of a method based on the method of FIG. 1, including optional features, such as annotation of the dataset, incorporation of received datasets into the patient database, automatically generating a diagnosis, and/or filtering of data, in accordance with some embodiments of the present invention. The method of FIG. 3 may be executed by the system described with reference to FIG. 2.

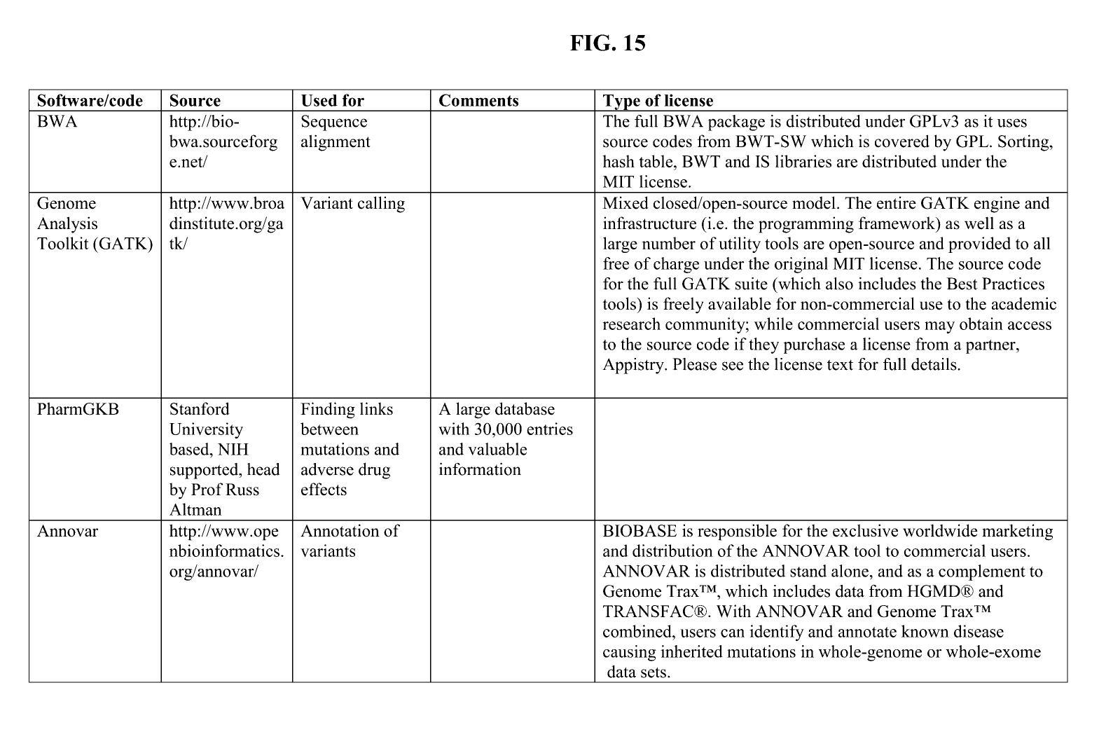

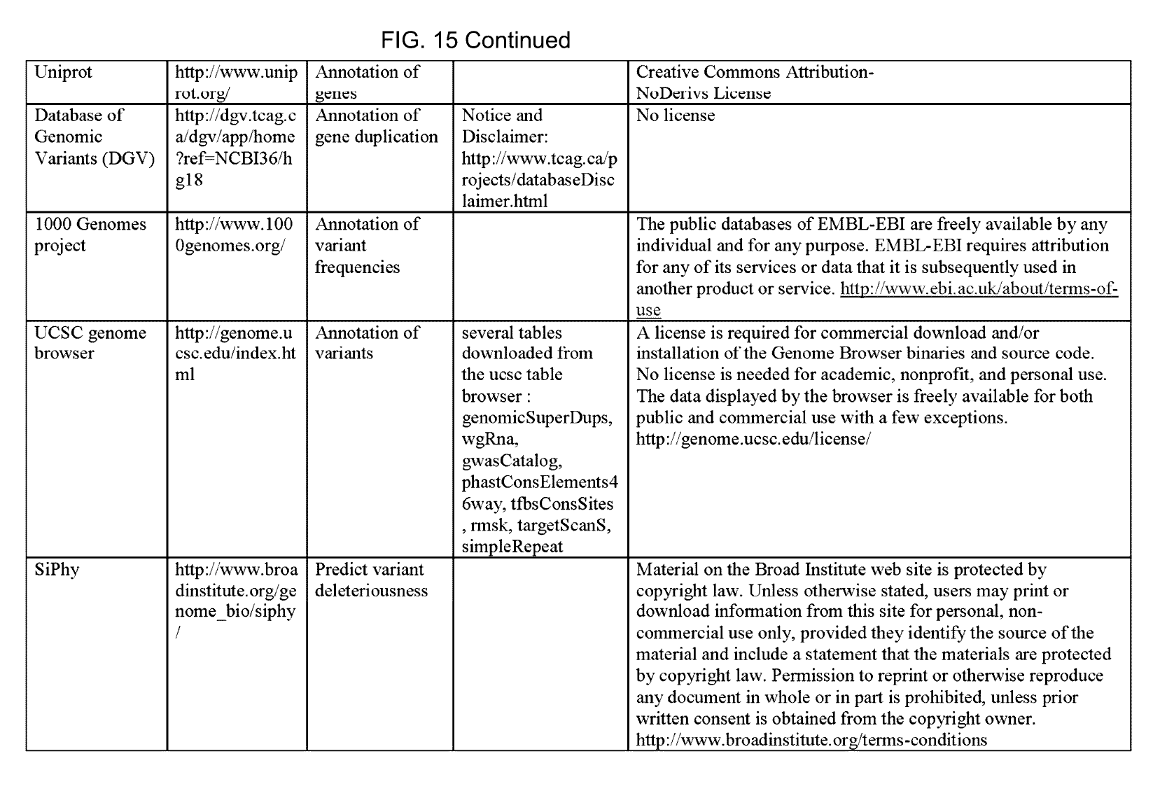

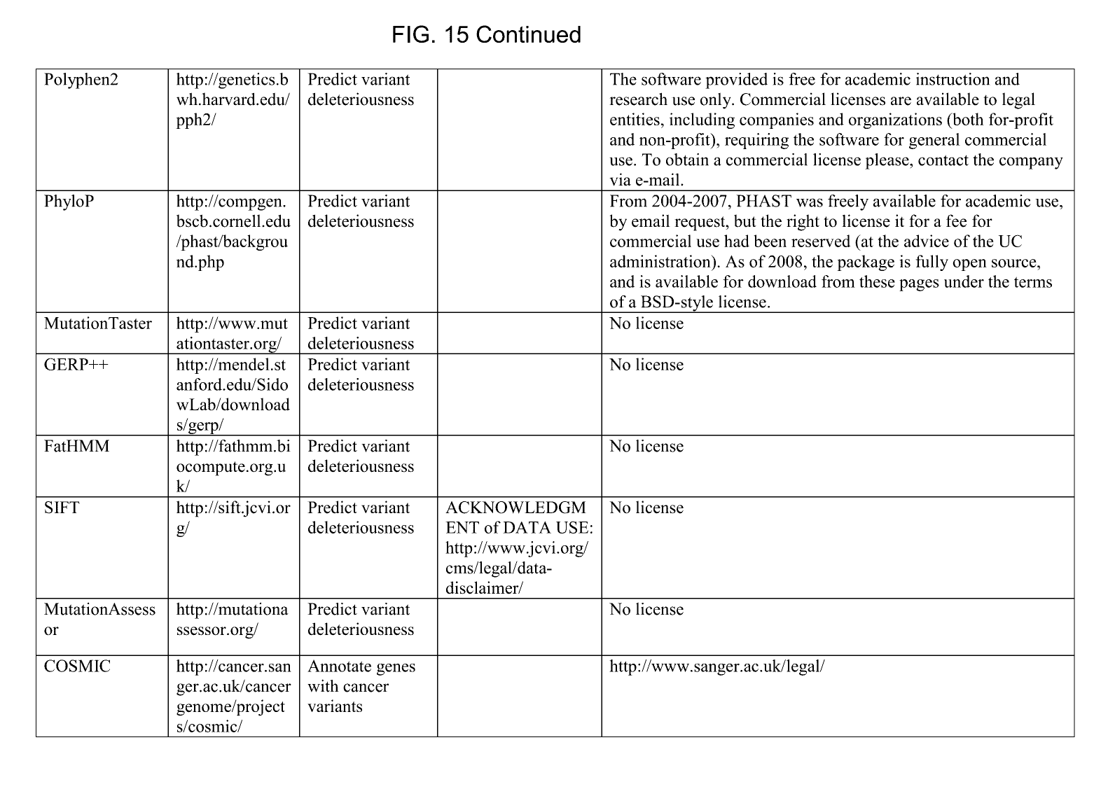

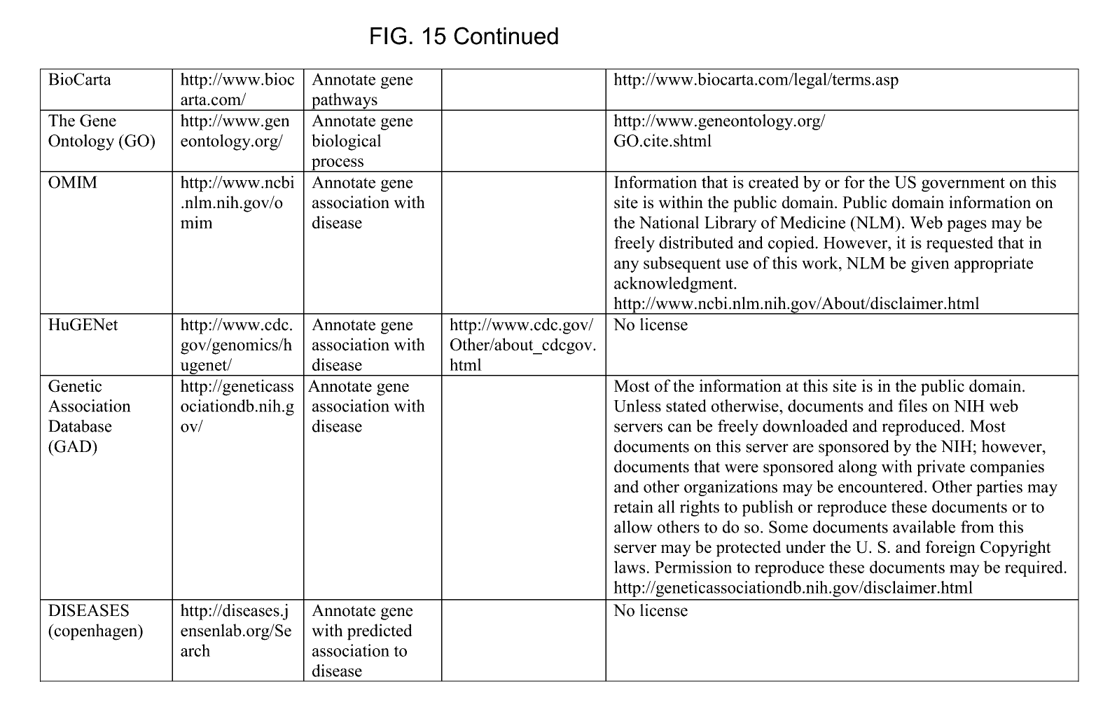

Optionally, at 302, a code (e.g., an annotation module 232) implementable by processor 204 of matching unit 202 annotates dataset(s) (e.g., a set of genetic variants) with information gathered from various public and/or private sources, for example, from third party databases 212 accessed by matching unit 202 via network 214. Examples of third party databases 212 are listed, for example, with reference to the table of FIG. 15. The variant information may be annotated automatically by the annotation module and/or manually by a user, using a combination of public tools (e.g., ANNOVAR) and/or in-house scripts, for example, with information gathered from the resources described in FIG. 15.

Subject dataset 224 may be annotated, for example, by code of client terminal 210, as described herein. Patient datasets stored in dataset 218 may be annotated as described herein. Other data (e.g., variants) may be annotated, as described herein.

When specified (e.g., manually by a user or automatically by software), the sequenced individual set of phenotypic manifestations (e.g., the subject's and/or patients' from database 218) may be integrated into the analysis and/or variants may be annotated according to their genetic association to the specified traits. Optionally, the gathered information (genetic and/or phenotypic) is integrated, and/or variants are classified, and/or prioritized, according to rarity and/or clinical relevance, for example, as described herein in reference to calculation of the ranking score.

Genes that are affected by the received variants may be annotated by the described resources.

Code implementable by a processor (e.g., client module 216), which may be located on or in communication with client terminal 210 prioritizes the variants in a genome (e.g., the subject's and/or the patients from database 218) based on defined annotated features.

Optionally, genes that are affected by the input variants are annotated by the described resources.

Optionally, the annotated patient datasets are uploaded into database 218 by matching unit 202 (e.g., uploaded into a computing cloud-based database).

Alternatively or additionally, the annotated data-set may be uploaded into a cloud-based database (or compared locally) and compared based on the phenotype and/or genetically compared against previously analyzed patients (local and/or global). Optionally, a description of the common genetic traits found in patients demonstrating similar phenotypes is provided as an output. This common genetic information may then be considered by the treating physician to come up with a final conclusion regarding the genetic association and/or possible causation to the phenotype, symptoms or disease.

The ranking score may be calculated according to the annotated values. For example, a high correlation similarity may be assigned to similar (or the same) annotated values when the underlying genetic sequences are different (e.g., different mutations). In another example, the high correlation similarity is assigned when both the annotated values and genetic sequences are similar. In yet another example, the high correlation similarity is assigned when the annotated values are different, but the genetic sequences are the same or similar.

Block 302 may be executed, for example, before block 102 of FIG. 1.

Optionally, at 304, dataset 224 transmitted from client terminal 210 to matching unit 202, which may include the subject's genetic information and/or phenotypic information, variants data, and/or datasets of other subjects, are added to database 218. The incorporation of the user provided data into database 218 expands the available patient datasets for future matches.

Database 218 gathers genetic and/or phenotypic information of each user that has uploaded datasets to matching unit 202. These datasets may be queried according to the specific needs of the physician at any time, and/or possibly integrated with a specific individual's genetic data, in order to improve diagnosis and/or prognosis through unification of genetic and phenotypic data, as described herein.

Block 304 may be executed, for example, before block 104 or after block 108, of FIG. 1.

Optionally, at 306, the datasets of the matched patients (e.g., as described with reference to blocks 106 and/or 108) are filtered by code (e.g., a filtration module 230) implemented by processor 204 of matching unit 202, and/or by code implemented by the processor of the client terminal. Filtration may reduce the matched list to the most relevant matches. Alternatively or additionally, the datasets of patients stored on database 218 (e.g., as described with reference to block 104) are filtered. Filtration may reduce the number of patient datasets for which the ranking score is calculated, to the most relevant patient datasets. Ranking scores may not be calculated for the remaining non-relevant datasets, improving efficiency of computation.

Optionally, the dataset of the matched patients are filtered according to data stored on a database (e.g., a remote database such as third party database 212, and/or locally on matching unit 202) including genetic mutations and/or polymorphisms. The datasets are filtered to identify known mutations and/or polymorphisms defined by the database.

Alternatively or additionally, the datasets of the matched patients are filtered according to data stored on the database to identify unknown mutations and/or unknown polymorphisms that are not defined by the database. The identification of unknown mutations and/or unknown polymorphisms may define the diagnosis of a new medical condition and/or disease.

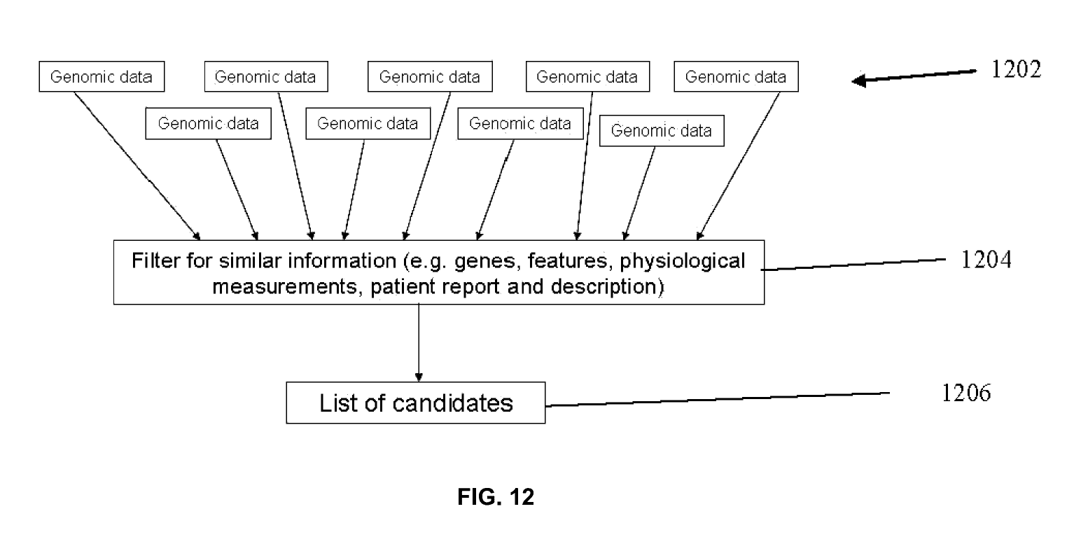

Reference is now made to FIG. 12, which is a graphical representation of a method of filtering patient datasets, in accordance with some embodiments of the present invention. Block 306 of FIG. 3 may be implemented by the method of FIG. 12.

At 1202, patient datasets including genomic data, which may be obtained from database 218 and/or from client terminal 210 (e.g., provided by the user) is received by matching unit 202. Optionally, the patient datasets include additional related information, for example, annotated genes, features, physiological measurements, patient medical history, and/or phenotype descriptions.

At 1204, the patients datasets may be filtered according to predefined filtration criteria, to exclude and/or include certain patient datasets, for example, include patients of a similar age, and exclude patients that have normal blood pressure.

At 1206, the filtered list of candidate patient datasets may be processed as described herein, for example, calculation of ranking score (e.g., block 104) and/or matched (e.g., block 106).

Optionally, at 308, the subject is automatically diagnosed with a medical condition by code implemented by the processor of matching unit 202 and/or client terminal 210. The diagnosis may be automatically made based on the matching patient dataset. For example, a subject having a rare manifestation of a certain genetic mutation may be diagnosed when another patient having similar correlated phenotype and/or genetic mutations is matched, such as according to the diagnosis of the matched patient.

Optionally, the diagnosis is automatically made by the code by identifying a genetic association for the phenotypic disease description of the subject based on the genetic information of the matched patients.

Alternatively, the matched patient datasets are manually considered by the user (e.g., treating physician) to come up with a final conclusion regarding the genetic association and/or possible causation to the phenotype and/or disease.

The diagnosis may be made quickly, manually by the physician and/or automatically by the code, as opposed to other methods, for example, sending special inquiries to different specialists for a diagnosis.

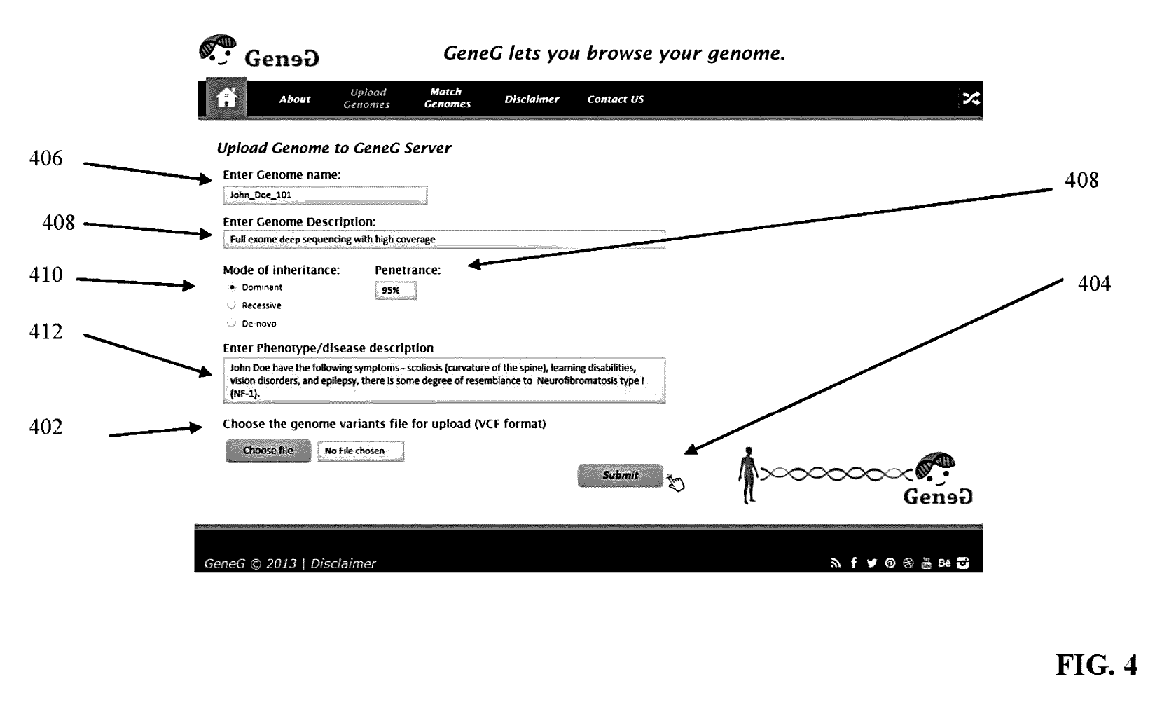

Reference is now made to FIG. 4, which is a screen shot of a GUI of a matching system on a display of a client terminal (e.g., as described with reference to FIG. 2), in accordance with some embodiments of the present invention. FIG. 4 illustrates an exemplary interface for uploading data of a genome of a patient, such as from a memory in communication with the client terminal to a central server, for matching by the matching unit, as described herein.

Optionally, at 402, a genome variants file including metadata representing genetic variations may be selected and uploaded from the client to the central server, for use in the matching process. The genome variants file may be encoded in a standard format, for example, the variant call format (VCF) format.

The genome and optional genome variants file may be uploaded with a single click, for example, by clicking the Submit button 404.

The GUI may allow entering a Genome name 406 to assign to the dataset of the subject for transmission to the server, entering a Genome Description 408 to assign to the dataset of the subject for transmission to the server, selecting the Mode of Inheritance 410, selecting the percent Penetrance 412, and/or entering a Phenotype/disease description 414 (as described herein).

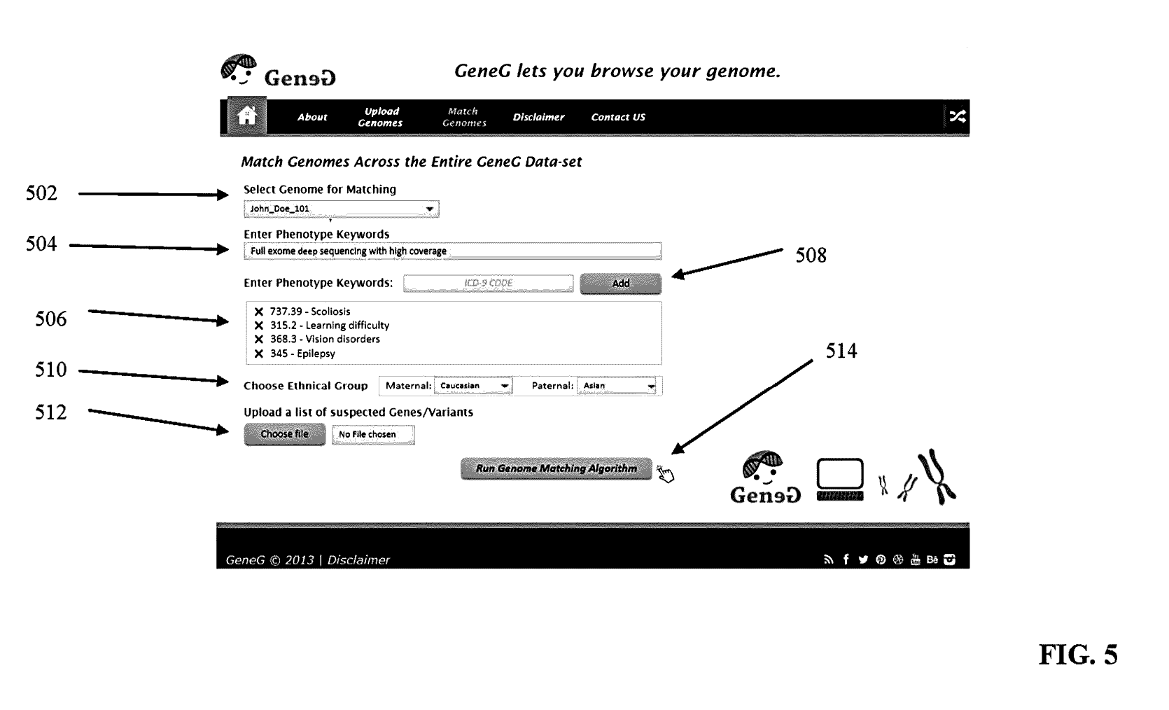

Reference is now made to FIG. 5, which is another screen shot of the GUI of the matching system on the display of the client terminal (e.g., as described with reference to FIG. 2), in accordance with some embodiments of the present invention. FIG. 5 illustrates an exemplary interface for entering parameters to control the matching process of the uploaded genome data of the subject (e.g., selected by a pull down menu 502 under Select Genome for Matching) with datasets of patients stored in the database accessible by the central server.

Matching is performed based on phenotypic disease expressions as described herein, which may be entered using keywords 504, and/or entered using predefined codes 506, for example, based on International Classification of Diseases (ICD) diagnostic codes, such as ICD-9. Phenotype Keywords 504 may be entered to search through the ICD-9 database, to select the desired phenotypic disease expressions to be used as a basis for matching. The identified phenotypic disease descriptions may be added to a list by pressing Add button 508. Alternatively or additionally, text entered as part of the phenotypic expression (e.g., 412 of FIG. 2) is parsed to identify the phenotypic keywords, which may be selected and/or changed by the user.

Additional criteria may be entered, for example, Ethnical group 510. The additional criteria may help to select more relevant matches, by improving the accuracy of the matched patient data to the most clinically relevant matches, for example, as people of similar ethnic background may have most similar phenotypic expression of similar genetic variations. A list of suspected Genes/Variants 512 may be selected for uploading to the matching unit. The efficiency of the search may be improved by focusing the matching to the suspected variants.

The search may be executed with a single click, by pressing Run Genome Matching Algorithm button 514.

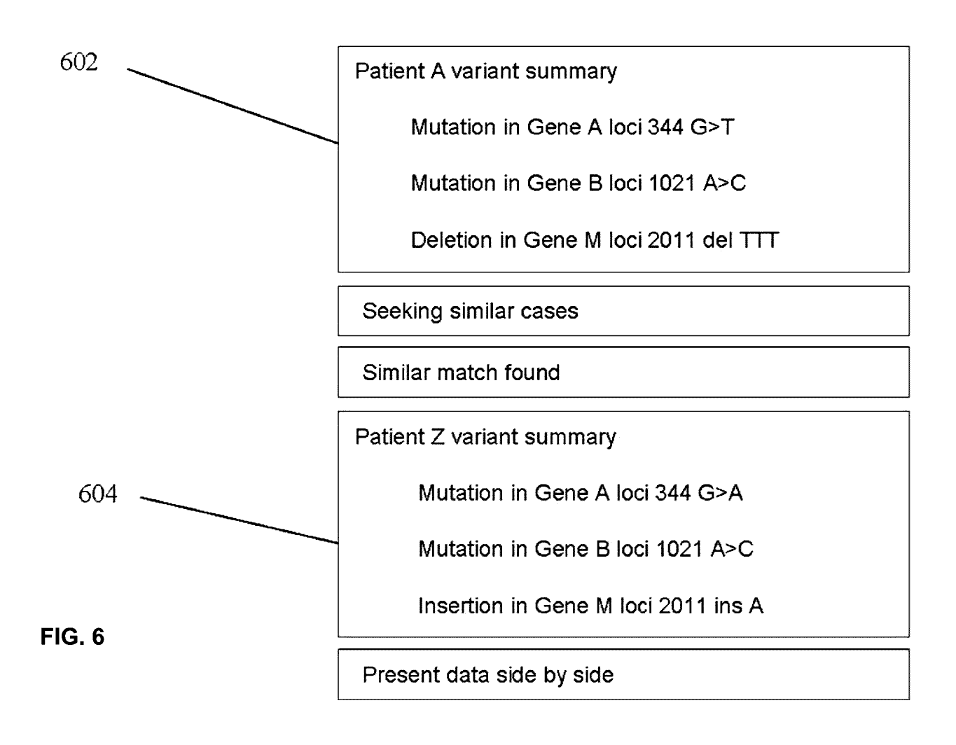

Reference is now made to FIG. 6, which is another screen shot of the GUI of the matching system on the display of the client terminal (e.g., as described with reference to FIG. 2), in accordance with some embodiments of the present invention. FIG. 6 illustrates an exemplary interface for displaying the resulting matches between the data of the subject and the data of the patients of the database. Optionally, the uploaded variations of genetic mutations (e.g., uploaded in FIGS. 4 and/or 5) are considered in the matching. Block 602 displays a summary of the data of the subject uploaded by the client to the matching unit. Block 604 displays a summary of the data of the matched patient. The patient shown in block 604 may be the highest ranked patient, according to the highest ranking score, such as based on the highest calculated correlation. The matched data may be displayed, for example the same mutation, and/or a different mutation at the same loci in the same gene.

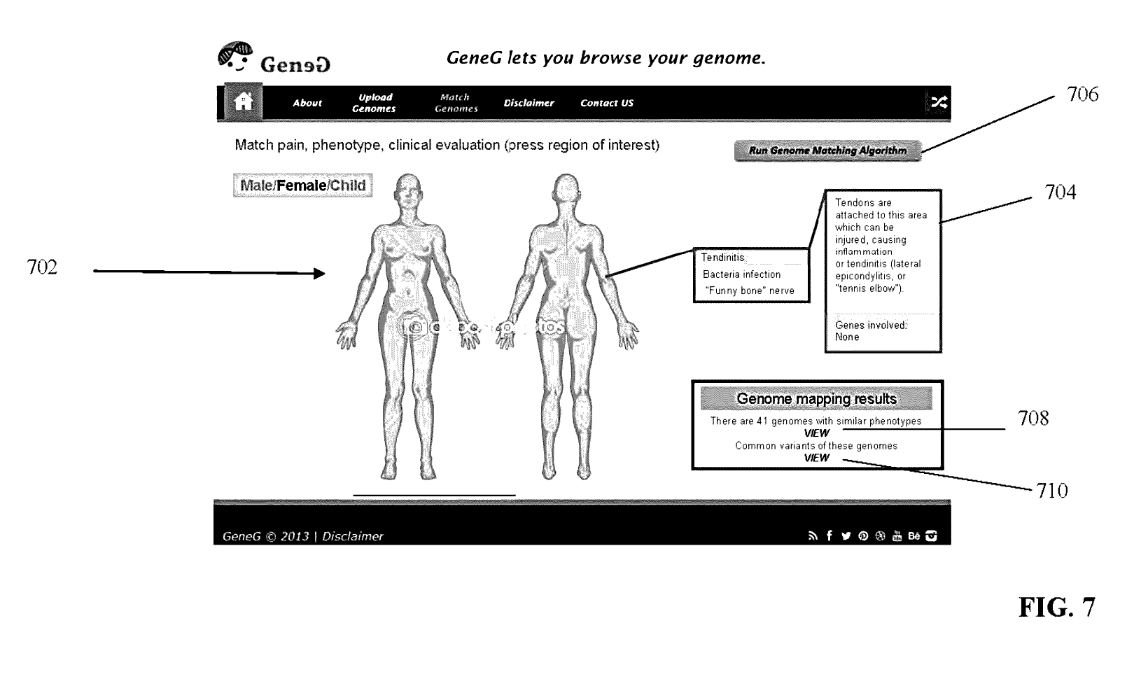

Reference is now made to FIG. 7, which is another screen shot of the GUI of the matching system on the display of the client terminal (e.g., as described with reference to FIG. 2), in accordance with some embodiments of the present invention. As shown in FIG. 7, a user may graphically select the phenotypic disease description to provide to the matching unit (e.g., pain, phenotype, clinical evaluation), based on a picture of a human (e.g., male, female, child) 702. Shown is an example in which the user pressed on the right elbow region of the posterior image of a woman. Options for phenotypic disease descriptions of the elbow may appear in a menu 704 (e.g., tendinitis, bacterial infection, “Funny bone” nerve). The displayed phenotypic disease descriptions may be selected from menu 704. Known genes associated with the selected phenotypic disease descriptions may be displayed, for example, based on the annotated genetic database or other databases. The genetic sequence of the subject associated with the phenotypic disease description may be displayed and/or selected. Multiple phenotypic disease descriptions with optional related genes may be entered in this manner for matching. The graphical picture of the human and related pop-up menu may allow the user to quickly enter multiple phenotypic expressions.

The user may run the matching algorithm (e.g., by selecting Run Genome Matching Algorithm button 706), to find patients with matching phenotypic disease descriptions. The matching may be performed to match the genetic sequence of the subject underlying the phenotypic disease descriptions, and/or to match common variants of the genetic sequence of the subject, as described herein. The genomes of the matched patients may be displayed (e.g., by selecting VIEW link 708). The common variants of the matched genomes may be displayed (e.g. by selecting VIEW link 710). Another search may be performed (e.g., to reduce the number of matches) as described herein, for example, by adding additional phenotypic disease descriptions, or limiting the search results in other ways.

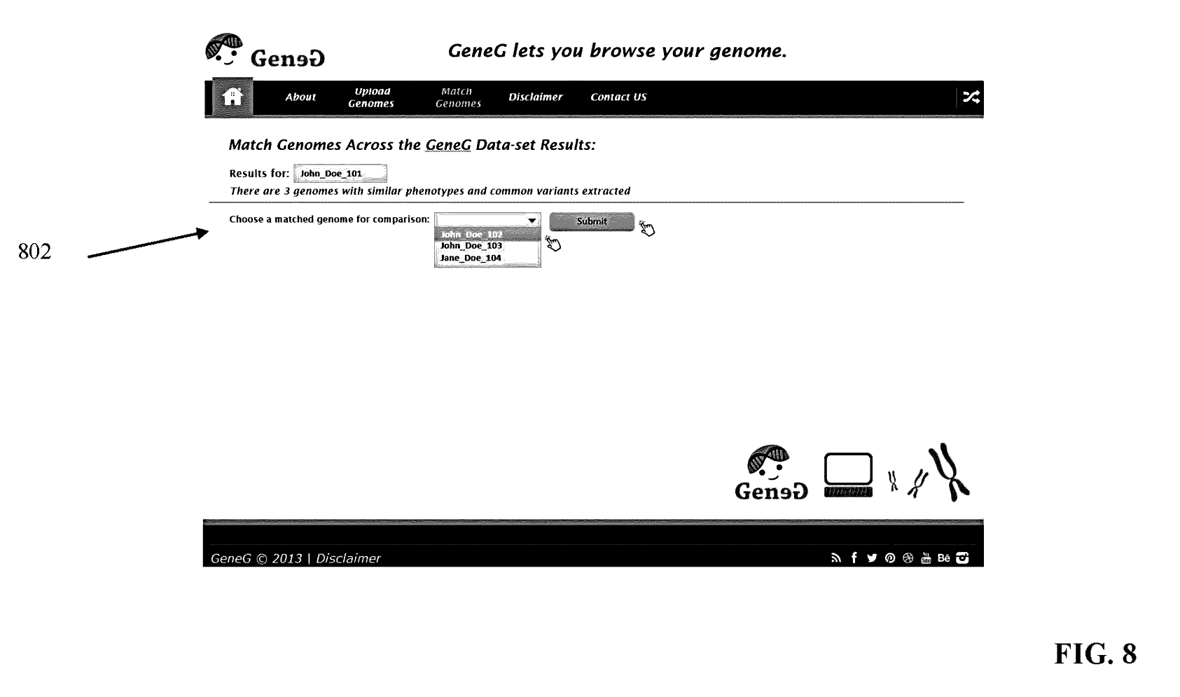

Reference is now made to FIG. 8, which is another screen shot of the GUI of the matching system on the display of the client terminal (e.g., as described with reference to FIG. 2), in accordance with some embodiments of the present invention. When multiple datasets of different patients have met the matching criteria (e.g., above the similarly correlation requirement), the GUI allows selection of a certain genome from the multiple matched genomes for focused and/or direct comparison. The user may choose a matched genome for comparison from a drop-down menu (or other selection methods).

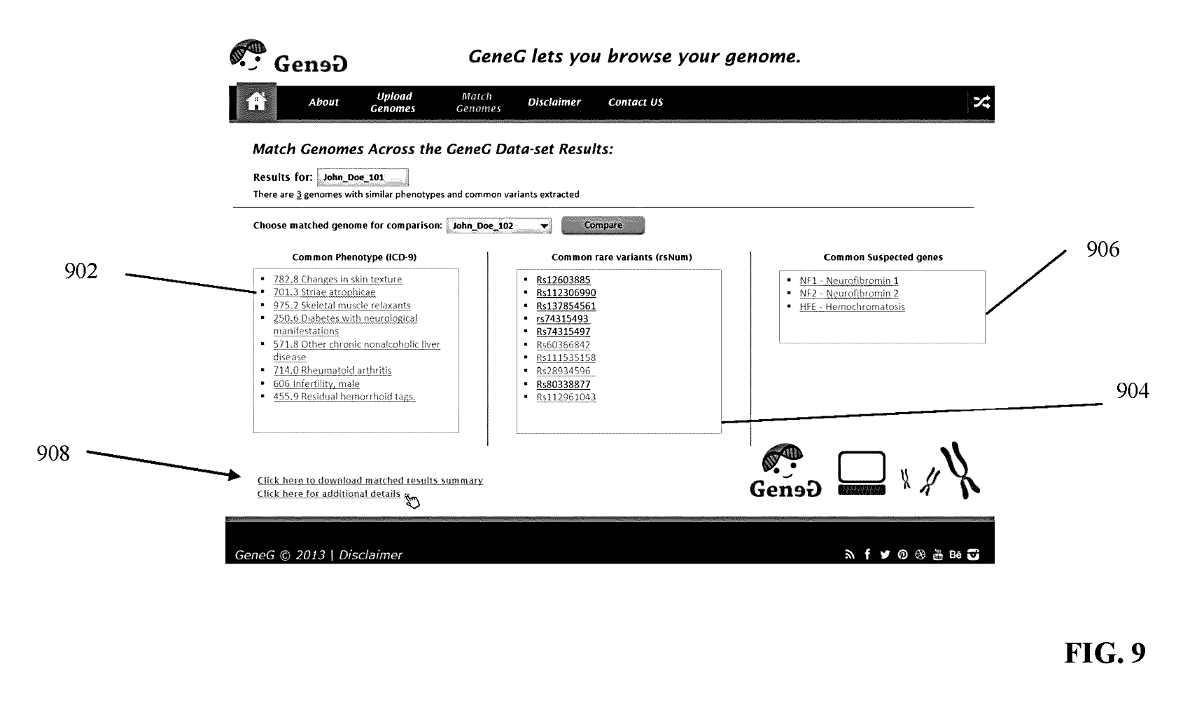

Reference is now made to FIG. 9, which is another screen shot of the GUI of the matching system on the display of the client terminal (e.g., as described with reference to FIG. 2), in accordance with some embodiments of the present invention. FIG. 9 may follow FIG. 8, after the user has selected the genome for comparison.

The phenotypic disease expressions and/or genetic information common to both the subject and the matched selected patient (i.e., John Doe 101 and John Doe 102) may be displayed by the GUI, such as: a list of ICD-9 codes for the Common Phenotype 902 and/or a list of Common rare variants 904 (e.g., based on the rs number (rsNum)). The common rare variants may be based on single nucleotide polymorphism. Common Suspected genes 906 may be displayed, based on matches in genetic sequences and/or variants. The user may click on any of the identified matches to obtain additional information, for example, a definition of the match.

The match results may be downloaded from the central server to the client terminal by pressing on the relevant link 908. Additional detail may be obtained by pressing on the relevant link.

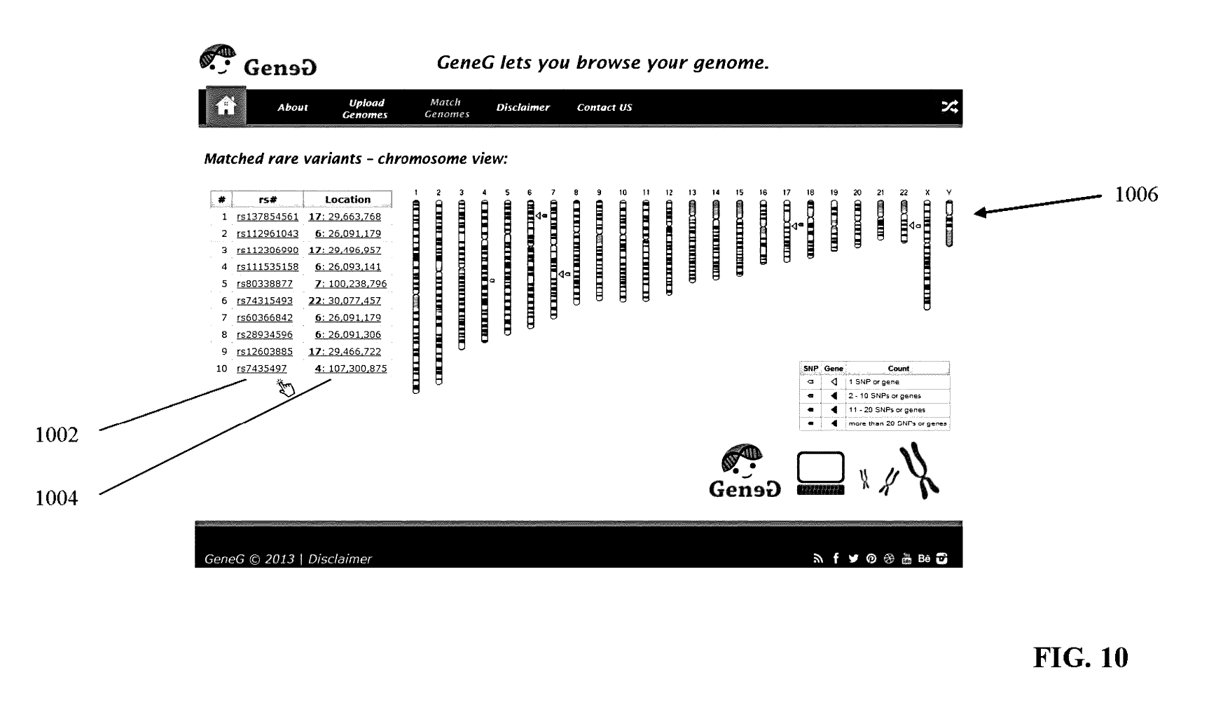

Reference is now made to FIG. 10, which is another screen shot of the GUI of the matching system on the display of the client terminal (e.g., as described with reference to FIG. 2), in accordance with some embodiments of the present invention. FIG. 10 is a visual display of the identified rare single point mutations that are common to the subject and matching patient. The matched rare variants may be displayed in a variety of ways. As shown, the matched rare variants are displayed based on: rs number 1002, location 1004 (i.e., number on the chromosome), and a visual display 1006 indicating the location on the chromosomes (e.g., based on color coding and/or arrows). The user may click on any of the matching information (rs#, location, visual display) to obtain additional details of the mutation, for example, the change in nucleotide, associated clinical effect, or other details.

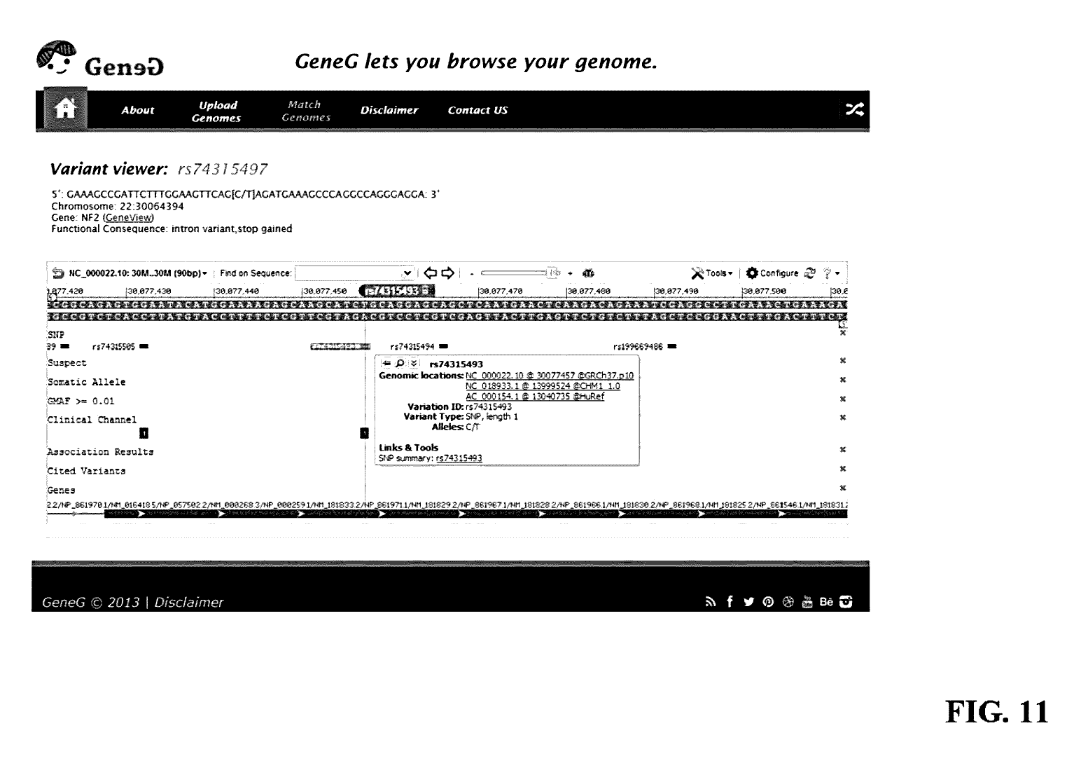

Reference is now made to FIG. 11, which is another screen shot of the GUI of the matching system on the display of the client terminal (e.g., as described with reference to FIG. 2), in accordance with some embodiments of the present invention. The GUI allows viewing variations of the genetic sequence based on a matched phenotypic disease description. Viewing the variations may help the user decide if the matching phenotypic disease descriptions are related based on underlying genetic information, or if the match is based on coincidental and/or non-relevant factors. Viewing the variations may help in diagnosing the subject, for example, when the matched subject and patient (that display similar phenotypic disease descriptions) suffer from the same disease due to variations in underlying genetic sequences. Alternatively, when the subject and the matched patient data have correlated phenotypic disease descriptions, but the genetic sequences and variations of the genetic sequence do not match according to the similarity correlation requirement, the match may be designated as a mistake, a coincidence, and/or related to non-relevant factors.

It is noted that the matching module for comparison and/or matching described herein is not necessary limited to matching based on medical conditions such as diseases. The matching module may be implemented to carry out matches and/or compare two or more individuals irrespective of their medical conditions, for example, the matching may be performed between healthy people. The terms subject, and patient, may describe healthy individuals, and/or individuals that may not be considered sick. The term phenotypic disease description is not necessarily limited to medical conditions, and sometimes may refer to a phenotypic expression that is not necessarily based on an underlying disease and/or medical condition, for example, blood type, drug metabolism ability, body shape, and/or other physiological variations which may fall within the limits of normal and/or healthy.

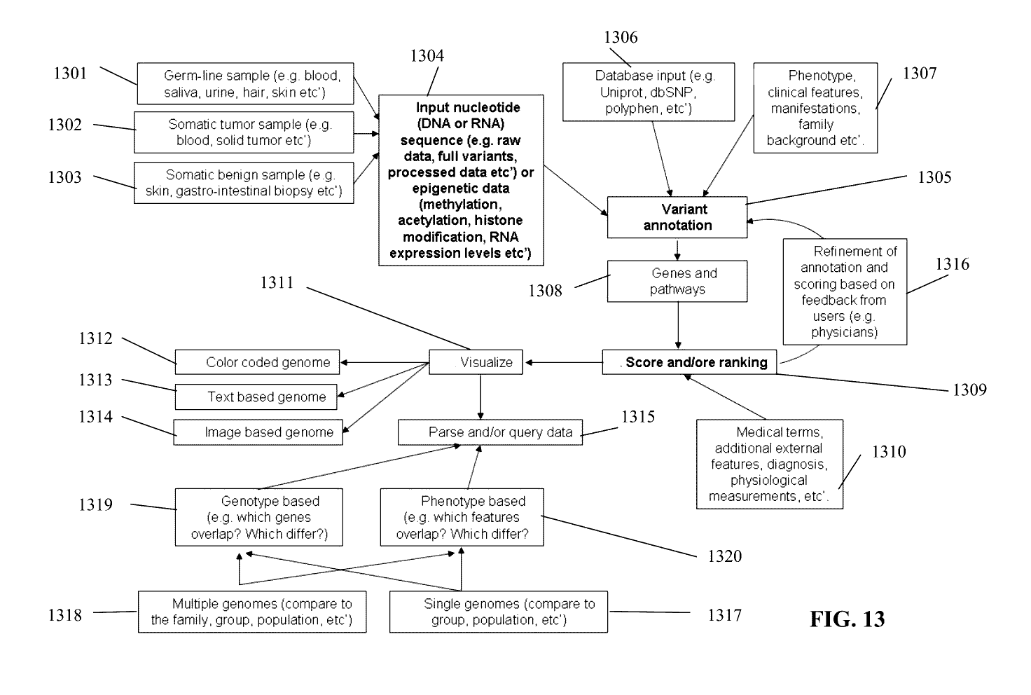

Reference is now made to FIG. 13, which is a flowchart of a method of comparing genetic information based on similarity of colors, in accordance with some embodiments of the present invention. The method of FIG. 13 may be executed by the system 200 described with reference to FIG. 2. The method of FIG. 13 may be combined with the method of FIG. 1.

Optionally, 1301, a germ-line sample is obtained from a subject, for example, from blood, saliva, urine, hair, and/or skin. Alternatively or additionally, at 1302, a somatic tumor sample is obtained from the subject, for example, from blood, or from the solid tumor. Alternatively or additionally, at 1303, a somatic benign sample is obtained from the subject, for example, from the skin, and/or from a gastro-intestinal biopsy.

At 1304, the obtained sample is sequenced to obtain a nucleotide sequence (e.g., DNA and/or RNA) to generate a subject dataset and/or patient dataset as described herein (e.g., dataset 224 and/or dataset of block 102). The sequence may include raw data, and/or variants of the processed data. The dataset may include epigenetic data, for example methylation, acetylation, histone modifications, and/or RNA expression levels.

Optionally, at 1305, the variant of the sequence may be annotated automatically (e.g., by annotation module 232 of FIG. 2) and/or manually, as described herein. Optionally, at 1306, annotation is based on database input, for example, third party dataset 212, and/or as described in FIG. 15. Alternatively or additionally, at 1307 the dataset includes and/or annotation is performed based on phenotype, clinical features, manifestations, family background, medical treatments, and/or other medical history.

Optionally, at 1308, certain genes and/or pathways are identified automatically by the matching unit and/or manually by the user, for example, rare genes and/or common genes, as described herein.

At 1309, the patient datasets are scored and/or ranked relative to the subject dataset, by matching unit, as described with reference to blocks 104 and/or 106. Optionally, at 1310, the ranking score is calculated according to one or more sub-scores, and/or the matching is performed according to one or more sub-requirements, for example, medical terms, additional external features, diagnosis, and/or physiological measurements, as described with reference to blocks 104 and/or 106.

At 1311, the matched datasets are presented by GUI 222 on display 220 of client terminal 210, as described herein, for example, with reference to block 108. Optionally, at 1312, the displayed matched datasets (e.g., genomes and/or other data) are color coded. Alternatively or additionally, at 1313, the text of the genomes (and/or other data) of the matched datasets is displayed. Alternatively or additionally, at 1314, the matched datasets are displayed as images.

Optionally, at 1315, the received matched datasets are parsed and/or queried, using instructions received from the user via GUI 222. For example, the user may select matched genetic mutations to follow a link to a web site providing additional details of the mutation.

Optionally, at 1316, the annotation and/or scoring method is refined based on feedback from the users (e.g., physicians). The refinement may be manually performed by the user and/or automatically by the matching unit, by manually and/or automatically adjusting the annotation and/or scoring method. The refinement may improve the matching processes, to achieve improved matches according to user preferences.

Optionally, at 1317, a single subject dataset is received by matching unit 202, for matching against the patient dataset stored in database 218. Alternatively, or additionally, at 1318, multiple subject datasets are received by matching unit 202, for matching against one another and/or for matching each subject dataset against patient datasets stored in database 218.

Matching may be based on genotype data 1319 (e.g., which genes overlap, and/or which genes are different) and/or phenotype data 1320 (e.g., which features overlap and/or which features are different) associated with each dataset, as described herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms phenotypic disease description, and ranking score are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A computer implemented method for matching subject data to database patient data based on matching phenotypes and related genetic sequences, comprising:
using at least one hardware processor for:
receiving at least one phenotype disease description of a subject and a genetic sequence of the subject, the phenotype disease description describing clinically significant manifestations of disease in the subject;
calculating a similarity correlation between the at least one phenotype disease description of the subject and the genetic sequence of the subject and each of a plurality of patient datasets each comprising a patient genetic sequence and a patient phenotype disease description of one of a plurality of documented patients, wherein the patient genetic sequence underlying genetic mutations attributable to the respective patient phenotypic disease description;
matching the at least one phenotype disease description of the subject and the genetic sequence of the subject with a group of patients documented by some of the plurality of patient datasets according to the similarity correlation; and
formatting, data indicative of the matched patients for a presentation on a display.

2. The method of claim 1, further comprising using at least one hardware processor for ranking the matched patients based on a ranking score calculated according to respective said similarity correlation, and providing the highest ranked matched patients according to a predefined requirement.

3. The method of claim 1, further comprising receiving subject dataset of said subject; wherein the subject dataset and each said patient dataset includes additional data selected from the group consisting of: geographic location, ethnic background, physiological measurements, medical treatments, family history, age, and gender, and wherein the ranking score includes a sub-score indicative of the similarity correlation between the additional data of the subject dataset and each patient dataset.

4. (canceled)

5. The method of claim 1, wherein said matching comprises correlating based on variations of the related genetic sequences of patients in the database.

6. The method of claim 1, wherein the formatting is held to visually indicate similar genetic sequences and/or similar phenotypic disease descriptions.

7. The method of claim 1, wherein the formatting is held to visually indicate differences in genetic sequences and/or differences in phenotypic disease descriptions.

8. The method of claim 1, wherein the formatting is held for color coding related genetic sequences of the dataset of the patients and the dataset of the subject, wherein similar colors indicate similar genetic sequences.

9. (canceled)

10. The method of claim 89, wherein the phenotypic disease description comprises metadata indicative of a disease diagnosis; wherein the disease diagnosis is based on International Classification of Diseases (ICD) diagnostic codes.

11. The method of claim 2, wherein the ranking score is calculated based on a sub-score indicative of clinical relevance of the phenotypic disease description.

12. The method of claim 2, wherein the ranking score is calculated based on at least one of: a sub-score indicative of rarity of the phenotypic disease description and a sub-score indicative of rarity of genetic mutations underlying the phenotypic disease description.

13. The method of claim 21, wherein the ranking score is calculated based on a sub-score indicative of an additional similarity correlation in phenotypic disease descriptions of the dataset of the subject and the dataset of the matched patients.

14. The method of claim 1, wherein said formatting comprises formatting for said display at least one of: data representing shared genetic variations, and data representing shared gene mutations of the dataset of the subject and the dataset of the matched patients.

15. The method of claim 1, wherein matching comprises matching based on a comparison of similarity of phenotypic disease descriptions to generate a first matching list according to a first requirement, and reducing the first matching list to a second matching list based on a comparison of similarity of underlying genetic mutations attributable to the phenotypic disease descriptions according to a second requirement.

16. The method of claim 1, wherein said formatting comprises formatting for said display metadata indicative of a description of genetic traits common to both the subject and matched patients.

17. The method of claim 1, further comprising diagnosing at least one disease in the subject according to an analysis of the datasets of the matched patients; wherein diagnosing comprises identifying, by the matching unit, a genetic association for the phenotypic disease description defined in metadata related to the dataset of the subject based on the genetic information of datasets of the matched patients.

18. (canceled)

19. The method of claim 1, further comprising filtering the dataset of the matched patients according to data stored on a database of at least one of genetic mutations and polymorphisms, to identify at least one of known mutations and polymorphisms defined by the database.

20. (canceled)

21. The method of claim 2, wherein the ranking score is calculated based on metadata defining one or more user defined features.

22. The method of claim 24, wherein the ranking score is calculated based on metadata defining annotated variants of the dataset of matched patients according to genetic association of the variants to metadata of phenotypic disease description; wherein the annotation of the variants is based on a correlation with clinical relevance.

23. (canceled)

24. The method of claim 2, further comprising adjusting the calculated ranking score based on metadata including feedback from at least one user.

25. A system for matching a dataset including genotypes of a subject based on matching datasets including phenotypes and related genetic sequences, comprising:
an interface configured to receive at least one phenotype disease description of a subject and a genetic sequence of the subject, the phenotype disease description describing clinically significant manifestations of disease in the subject;
a non-transitory memory having stored thereon code;
a database storing unit, the database storing patient datasets of patients including at least one phenotypic disease description and related genetic sequences, wherein the related genetic sequences of patients stored in the database are underlying genetic mutations attributable to the at least one phenotypic disease description; and
a hardware processor coupled to the interface, the database storing unit, and the non-transitory memory for implementing the stored code, the code comprising:
code to calculate a similarity correlation between the at least one phenotype disease description of the subject and the genetic sequence of the subject and each of the plurality of patient datasets;
wherein the hardware processor is further configured to format data indicative of the matched patients for a presentation on a display.

26-32. (canceled)
